(19) United States
(12) Patent Application Publication
(10) Pub. No.: US 2025/0131352 A1
(43) Pub. Date: Apr. 24, 2025

(54) MANAGING ACCESS CHANGES TO ENTERPRISE RESOURCES

(71) Applicant: International Business Machines Corporation, Armonk, NY (US)

(72) Inventors: NEIL DELIMA, Scarborough (CA); Tiberiu Suto, Franklin, NY (US); Jonathan Asghar, Austin, TX (US); Neerju Gupta, Chelmsford, MA (US)

(21) Appl. No.: 18/490,932

(22) Filed: Oct. 20, 2023

(51) Int. Cl. G06Q 10/0631; G06Q 10/105

(52) U.S. Cl. CPC G06Q 10/06312; G06Q 10/105

(57) ABSTRACT

In an approach to managing access changes to enterprise resources, one or more computer processors detect a status change of an employment of a user in an enterprise. One or more computer processors retrieve an access level of the user associated with one or more enterprise resources. Based on the status change, one or more computer processors determine the access level of the user associated with at least one of the one or more enterprise resources needs to change. One or more computer processors determine whether the user is an owner of the at least one resource. In response to determining the user is an owner of the at least one resource, one or more computer processors retrieve an employee hierarchy. Based on the employee hierarchy, one or more computer processors assign temporary ownership of the at least one resource to a first employee of the enterprise.

### BACKGROUND OF THE INVENTION

The present invention relates generally to the field of asset control management, and more particularly to managing access changes to enterprise resources.

In physical security and information security, access control (AC) is the selective restriction of access to a place or other resource, while access management describes the process. The act of accessing may mean consuming, entering, or using. In recent years, access control has extended to digital platforms, making the protection of external databases to preserve digital security more important than ever. In computer security, general access control includes authentication, authorization, and audit, whereby the system makes a decision to grant or reject an access request from an already authenticated subject, based on what the subject is authorized to access. Authentication and access control are often combined into a single operation, so that access is approved based on successful authentication, or based on an anonymous access token.

By utilizing user accounts, people can simultaneously share a computer's file system, applications, and processors. A few attributes of a user account include: (i) file access privilege for a user; (ii) a user is allowed to make changes to components of the computer system; and (iii) user preferences, such as desktop background or color theme that can be modified. Conventionally, there are at least three different types of accounts: standard, administrator/owner, and guest. Each account type gives the user a different level of control over the computer. The standard account is a permanent long-term account for everyday computing. The administrator account provides the most control over the computer and should only be given when necessary. The guest account is primarily for users who need temporary access to the computer. Users of enterprise systems come and go, and as they depart, they may leave data accounts open to be dealt with by administrators. An orphan account is an operational account without a valid user.

### SUMMARY

Embodiments of the present invention disclose a computer-implemented method, a computer program product, and a system for managing access changes to enterprise resources. The computer-implemented method may include one or more computer processors detecting a status change of an employment of a user in an enterprise. One or more computer processors retrieve an access level of the user associated with one or more enterprise resources. Based on the status change, one or more computer processors determine the access level of the user associated with at least one of the one or more enterprise resources needs to change. One or more computer processors determine whether the user is an owner of the at least one resource. In response to determining the user is an owner of the at least one resource, one or more computer processors retrieve an employee hierarchy. Based on the employee hierarchy, one or more computer processors assign temporary ownership of the at least one resource to a first employee of the enterprise.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of an enterprise resource access transfer manager, on a server computer within the distributed data processing environment of FIG. 1, for managing access changes to enterprise resources, in accordance with an embodiment of the present invention; and

FIG. 3 illustrates an exemplary computer environment in which aspects of one or more of the illustrative embodiments may be implemented, and at least some of the computer code involved in performing the inventive methods may be executed, in accordance with an embodiment of the present invention.

### DETAILED DESCRIPTION

Managing and controlling access and ownership of resources and assets such as devices, accounts, application resources, cloud resources, etc., are important functions in an enterprise or organization. When there is a change to the attributes of an owner of an asset or a member of a group that has access to an asset, such as a role change or a departure from the enterprise, permissions and/or access privileges may need to be modified and ownership may need to be transferred. This can be a tedious process, and the workflow can involve retroactive updates based on certain access control policies. For example, a policy may be that annually, or after a pre-defined time period, a user is required to provide justification for continued access to a resource or asset. This issue may be amplified when the user is an owner or administrator of a resource and the user is no longer part of the enterprise or organization. In such situations, a resource may be orphaned which can result in users being locked out of the resource or delays in access approvals due to the absence of an owner. Role changes can also result in unauthorized access to confidential information, prevention of which is of critical importance.

Embodiments of the present invention recognize that resource security may be improved by providing a system that proactively detects a need to change ownership and/or access to a shared resource when a user changes roles in an enterprise. Embodiments of the present invention also recognize that asset control management may be improved by providing a system that can trigger a change to access control to a resource based on a type of role change. Embodiments of the present invention also recognize that efficiency may be gained by providing a system that can dynamically determine a suitable owner of a shared resource for which the original owner has changed roles. Implementation of embodiments of the invention may take a variety of forms, and exemplary implementation details are discussed subsequently with reference to the Figures.

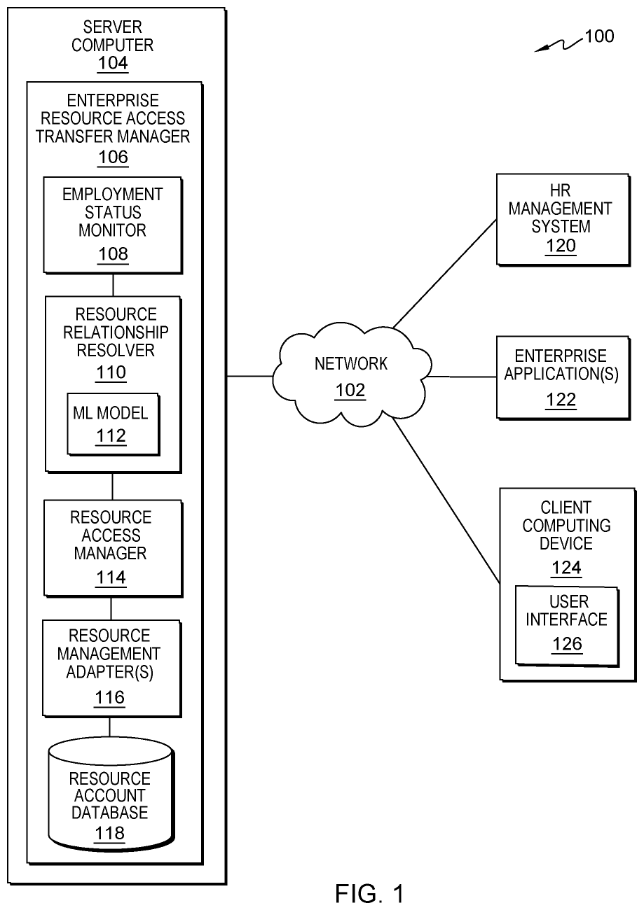

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

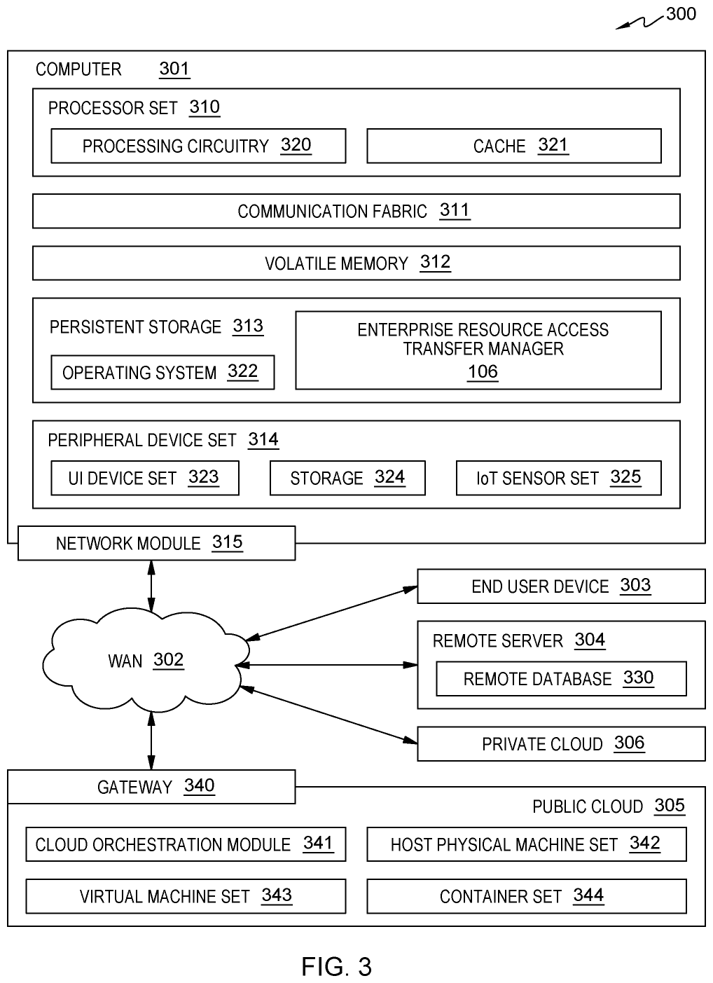

Distributed data processing environment 100 includes server computer 104, human resource (HR) management system 120, enterprise application(s) 122, and client computing device 124, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, HR management system 120, enterprise application(s) 122, client computing device 124, and other computing devices (not shown) within distributed data processing environment 100. Distributed data processing environment 100 may be implemented in computing environment 300 shown in FIG. 3.

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, an edge device, a containerized workload, or any programmable electronic device capable of communicating with client computing device 124 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes enterprise resource access transfer manager 106. Server computer 104 may include internal and external hardware components, as depicted and described in further detail with respect to computer 301 of FIG. 3.

Enterprise resource access transfer manager 106 addresses asset/resource ownership transfer and/or a change in access control in response to an organizational role change in an automated manner. Enterprise resource access transfer manager 106 intelligently updates access to an enterprise resource by detecting when access control changes are needed and determining new access privileges and ownership, if necessary, by discovering current resource access, user roles, user attributes, and resource attributes. Enterprise resource access transfer manager 106 takes into consideration the classification of the resource when determining an access control change. Enterprise resource access transfer manager 106 also recommends potential new owners of the resource based on user interaction with the resource and any relationship to the previous owner.

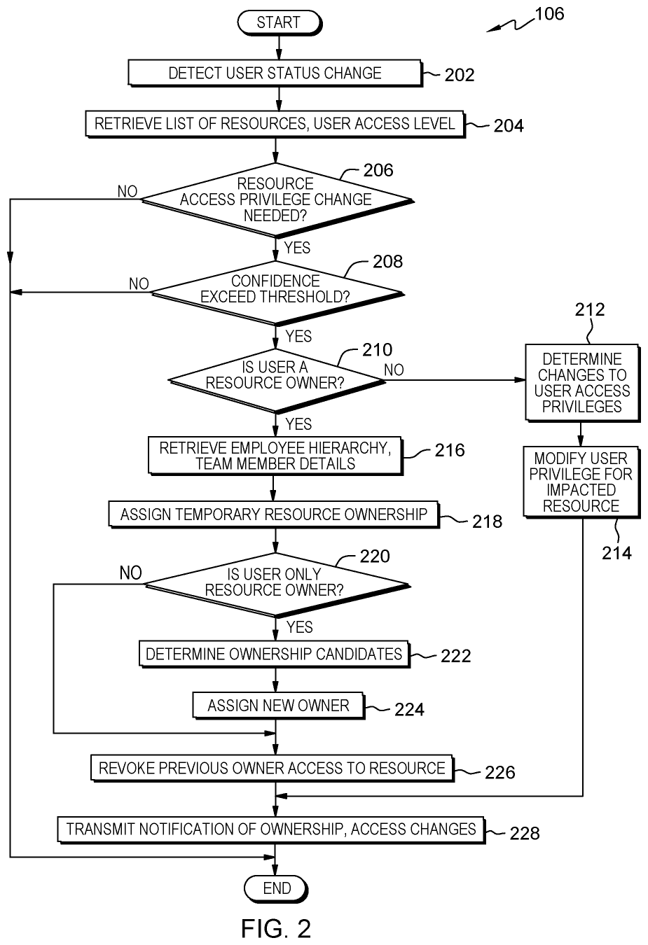

Enterprise resource access transfer manager 106 detects a user status change. Enterprise resource access transfer manager 106 retrieves a list of resources associated with the user as well as the access level of the user for each resource. Based on the retrieved list, enterprise resource access transfer manager 106 determines whether any resource access privilege change is needed. If enterprise resource access transfer manager 106 determines a resource access privilege change is needed, then enterprise resource access transfer manager 106 determines whether a confidence in the determination exceeds a threshold. If enterprise resource access transfer manager 106 determines the confidence in the determination exceeds a threshold, then enterprise resource access transfer manager 106 determines whether the user is an owner of the resource. If enterprise resource access transfer manager 106 determines the user is not an owner of the resource, then enterprise resource access transfer manager 106 determines changes to user access privileges and modifies the privileges for the impacted resource. If enterprise resource access transfer manager 106 determines the user is an owner of the resource, then enterprise resource access transfer manager 106 retrieves an employee hierarchy and team member details. Based on the retrieved employee hierarchy and team member details, enterprise resource access transfer manager 106 assigns temporary resource ownership. Enterprise resource access transfer manager 106 determines whether the user is the only owner of the resource. If enterprise resource access transfer manager 106 determines the user is the only owner of the resource, then enterprise resource access transfer manager 106 determines ownership candidates and assigns a new owner. If enterprise resource access transfer manager 106 determines the user is not the only owner of the resource, then enterprise resource access transfer manager 106 revokes the owner access privilege of the user. Enterprise resource access transfer manager 106 transmits a notification of ownership and access changes. Enterprise resource access transfer manager 106 includes employment status monitor 108, resource relationship resolver 110, resource access manager 114, resource management adapter(s) 116, and resource account database 118. Enterprise resource access transfer manager 106 is depicted and described in further detail with respect to FIG. 2.

Employment status monitor 108 monitors HR management system 120 for any changes in employee status. A change may include a role change, a department change, a team change, a title change, a level change, such as a promotion, a name change, etc. A change may also include whether the employee left the organization. In an embodiment, employment status monitor 108 monitors an enterprise directory for any changes in employee status.

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user's information may be recorded or monitored and may be saved, for the purpose of managing access changes to enterprise resources. These embodiments may also include periodic reminders of such recording and monitoring throughout the course of any such use. Certain embodiments may also include regular (e.g., daily, weekly, monthly) reminders to the participating parties that they have consented to being recorded and monitored for managing access changes to enterprise resources and may provide the participating parties with the opportunity to opt-out of such recording and monitoring if desired. Furthermore, to the extent that any non-participating parties' actions are monitored (for example, when outside vehicles are viewed), such monitoring takes place for the limited purpose of providing navigation assistance to a participating party, with protections in place to prevent the unauthorized use or disclosure of any data for which an individual might have a certain expectation of privacy.

Resource relationship resolver 110 resolves and/or establishes relationships between the user and the associated resource. Resource relationship resolver 110 also resolves and/or establishes relationships between the current owner of a resource and potential new owners and determines a recommendation for the next owner of the resource. Resource relationship resolver 110 establishes relationships between a user's access and the resource, and clusters users based on attributes, roles, and access level to the resource. Resource relationship resolver 110 includes machine learning model 112. Resource relationship resolver 110 uses machine learning model 112 to predict if changes are needed to access control privileges to a resource. Further, resource relationship resolver 110 uses patterns determined by machine learning model 112 to apply new access control privileges to the resource.

Machine learning (ML) model 112 is trained to establish semantic relationships between attributes of a current resource owner, other users with access privileges to the resource, and/or attributes or properties of the resource, either from the resource content or metadata associated with the resource. Attributes of the current resource owner and other users can include, but are not limited to, a department, a job role, a job function, a history of access to the resource, etc. ML model 112 scans HR management system 120, including employee directories which may be stored in resource account database 118, to determine attributes of the current resource owner and other users. Properties of the resource can include, but are not limited to, a resource type, an application type, a primary function, a classification of data, and other metadata associated with the resource. ML model 112 uses one or more known techniques to determine semantic equivalence between user attribute data and the resource data and thereby discover or resolve new access control privileges and/or a potential new owner if ML model 112 establishes a strong semantic relationship. Resource relationship resolver 110 uses ML model 112 to establish a pattern of access control changes based on clusters of resource types and user characteristics to predict new access control privileges.

Resource access manager 114 identifies current access privileges to enterprise application(s) 122 for each employee in the enterprise and manages any transfers of access and/or ownership.

Resource management adapter(s) 116 provide a communication interface between enterprise resource access transfer manager 106 and each enterprise resource included in enterprise application(s) 122. Resource management adapter(s) 116 are responsible for managing user access to resources within enterprise application(s) 122 via management interface application programming interfaces (APIs) provided by the application. For example, in a document management application, user resources are folders and files and access to the folders and files by the enterprise administrator can be managed via the management APIs associated with the document management system. Each application of enterprise application(s) 122 has an associated adapter included in resource management adapter(s) 116. Enterprise resource access transfer manager 106 uses credentials and API endpoints, stored in resource account database 118, to manage access to the corresponding application(s) 122 registered via the associated resource management adapter(s) 116.

In the depicted embodiment, resource account database 118 resides on server computer 104. In another embodiment, resource account database 118 may reside elsewhere within distributed data processing environment 100, provided that enterprise resource access transfer manager 106 has access to resource account database 118, via network 102. A database is an organized collection of data. Resource account database 118 can be implemented with any type of storage device capable of storing data and configuration files that can be accessed and utilized by enterprise resource access transfer manager 106 such as a database server, a hard disk drive, or a flash memory. Resource account database 118 stores information used by and generated by enterprise resource access transfer manager 106. For example, resource account database 118 stores changes in resource ownership and one or more notifications associated with the changes. Resource account database 118 also stores employee information, such as an enterprise directory, as well as access privileges of each employee. Resource account database 118 also stores details related to enterprise application(s) 122 as well as API endpoints for each of enterprise application(s) 122, where an API endpoint is a digital location where an API receives requests about a specific resource. For example, an API endpoint may be a uniform resource locator (URL) that provides the location of a resource in distributed data processing environment 100. In addition, resource account database 118 stores an account for each of enterprise application(s) 122 that includes permissions and appropriate credentials. Further, resource account database 118 stores any temporary ownership designations made by enterprise resource access transfer manager 106.

The present invention may contain various accessible data sources, such as resource account database 118, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Enterprise resource access transfer manager 106 enables the authorized and secure processing of personal data. Enterprise resource access transfer manager 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Enterprise resource access transfer manager 106 provides information regarding personal data and the nature (e.g., type, scope, purpose, duration, etc.) of the processing. Enterprise resource access transfer manager 106 provides the user with copies of stored personal data. Enterprise resource access transfer manager 106 allows the correction or completion of incorrect or incomplete personal data. Enterprise resource access transfer manager 106 allows the immediate deletion of personal data.

HR management system 120 is one or more of a plurality of HR software products that combines several systems and processes to ensure the easy management of human resources, business processes, and data. Human resources software is used by businesses to combine several necessary HR functions, such as storing employee data, managing payroll, recruitment, benefits administration (total rewards), time and attendance, employee performance management, and tracking competency and training records.

Enterprise application(s) 122 is one or more of a plurality of software applications used by an enterprise for various purposes. In an embodiment, enterprise application(s) 122 are applications that are owned by the enterprise and managed by the enterprise. For example, enterprise application(s) 122 may include a document management system. In another example, enterprise application(s) 122 may include an internal messaging program. In yet another example, enterprise application(s) 122 is a cloud service. In general, enterprise application(s) 122 is any enterprise application that requires access control for its users.

Client computing device 124 can be one or more of a laptop computer, a tablet computer, a smart phone, smart watch, a smart speaker, or any programmable electronic device capable of communicating with various components and devices within distributed data processing environment 100, via network 102. Client computing device 124 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, client computing device 124 may be integrated into a vehicle. For example, client computing device 124 may be a heads-up display in the windshield of the vehicle. In an embodiment where client computing device 124 is integrated into the vehicle, client computing device 124 includes a programmable, embedded Subscriber Identity Module (eSIM) card (not shown) that includes a unique identifier of the vehicle in addition to other vehicle information. In general, client computing device 124 represents one or more programmable electronic devices or combination of programmable electronic devices capable of executing machine readable program instructions and communicating with other computing devices (not shown) within distributed data processing environment 100 via a network, such as network 102. Client computing device 124 includes an instance of user interface 126.

User interface 126 provides an interface between enterprise resource access transfer manager 106 on server computer 104 and a user of client computing device 124. In one embodiment, user interface 126 is mobile application software. Mobile application software, or an “app,” is a computer program designed to run on smart phones, tablet computers and other mobile devices. In one embodiment, user interface 126 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In an embodiment, user interface 126 enables a user of client computing device 124 to receive notifications of resource access level and/or privilege changes.

FIG. 2 is a flowchart depicting operational steps of enterprise resource access transfer manager 106, on server computer 104 within distributed data processing environment 100 of FIG. 1, for managing access changes to enterprise resources, in accordance with an embodiment of the present invention.

Enterprise resource access transfer manager 106 detects a user status change (step 202). In an embodiment, a user that is an employee of an enterprise or organization changes to a new job, role, or attribute within the enterprise, changes employment status, or leaves the enterprise, and HR management system 120 captures the change by updating the system and/or an enterprise directory. In the embodiment, enterprise resource access transfer manager 106, using employment status monitor 108, detects the user status change. In an embodiment, employment status monitor 108 schedules a job that crawls the enterprise directory to consume change events published by HR management system 120. In another embodiment, employment status monitor 108 uses a pub/sub architecture to consume change events published by HR management system 120.

Enterprise resource access transfer manager 106 retrieves a list of resources associated with the user and the access level of the user (step 204). For example, access level may include, but is not limited to, owner, administrator, editor, read only, etc. In an embodiment, enterprise resource access transfer manager 106 uses employment status monitor 108 to communicate with resource access manager 114 regarding the user status change. In an embodiment, employment status monitor 108 communicates with and requests that resource access manager 114 fetch the existing resource access and privileges for the user from the enterprise directory. In an embodiment, resource access manager 114 leverages one or more of resource management adapter(s) 116 to fetch access and privileges for the user.

Enterprise resource access transfer manager 106 determines whether any resource access privilege change is needed (decision block 206). In an embodiment, based on the retrieved list, enterprise resource access transfer manager 106 determines whether the user had any access privilege to a resource that is no longer needed or permitted based on the status change of the user. In an embodiment, employment status monitor 108 invokes resource relationship resolver 110 upon detection of the user status change discussed with respect to step 202. In an embodiment, resource relationship resolver 110 uses ML model 112 to resolve new access privileges.

If enterprise resource access transfer manager 106 determines a resource access privilege change is needed (“yes” branch, decision block 206), then enterprise resource access transfer manager 106 determines whether a confidence in the determination exceeds a threshold (decision block 208). In an embodiment, enterprise resource access transfer manager 106, using resource relationship resolver 110, calculates a level of confidence associated with the determination that a resource access privilege change is needed. Resource relationship resolver 110 compares the calculated confidence level to a pre-defined threshold to determine whether the confidence level exceeds the threshold. For example, if the pre-defined threshold is 80 percent confidence, then resource relationship resolver 110 determines whether the calculated confidence exceeds 80 percent.

If enterprise resource access transfer manager 106 determines the confidence in the determination exceeds a threshold (“yes” branch, decision block 208), then enterprise resource access transfer manager 106 determines whether the user is an owner of the resource (decision block 210). In an embodiment, enterprise resource access transfer manager 106 reviews the resource access and privileges of the user retrieved by resource access manager 114, as discussed with respect to step 204, to determine whether the user had a status of owner for any of the resources with which the user had access.

If enterprise resource access transfer manager 106 determines the user is not an owner of the resource (“no” branch, decision block 210), then enterprise resource access transfer manager 106 determines changes to user access privileges (step 212). In an embodiment, based on the change in the status of the user, e.g., a job role change, enterprise resource access transfer manager 106 reviews the current access privileges of the user to one or more enterprise resources and determines whether any changes are required. For example, if the user had edit privileges in a document management resource and moved to a different department in the enterprise, then enterprise resource access transfer manager 106, using resource relationship resolver 110, determines if a user in the different department is authorized to have edit privileges in the document management resource or if the user no longer has a need-to-know in that resource.

Enterprise resource access transfer manager 106 modifies the user privilege for the impacted resource (step 214). In an embodiment, enterprise resource access transfer manager 106 invokes resource access manager 114 to trigger the corresponding resource adapter of resource management adapter(s) 116 to modify the resource access level, permissions, and/or privileges of the user for each resource for which user access must be changed.

If enterprise resource access transfer manager 106 determines the user is an owner of the resource (“yes” branch, decision block 210), then enterprise resource access transfer manager 106 retrieves an employee hierarchy and team member details (step 216). In an embodiment, resource access manager 114 invokes resource relationship resolver 110 to resolve the next potential owner of the resource. In an embodiment, enterprise resource access transfer manager 106, using resource relationship resolver 110, fetches an employee hierarchy and team member details. For example, resource relationship resolver 110 retrieves a management chain listing from the enterprise directory stored in resource account database 118. In another example, resource relationship resolver 110 retrieves identification information of other employees with access privileges to the same resources as the user from HR management system 120.

Enterprise resource access transfer manager 106 assigns temporary resource ownership (step 218). Based on the retrieved employee hierarchy and team member details, enterprise resource access transfer manager 106, using resource relationship resolver 110, determines temporary resource ownership and, using resource access manager 114, assigns temporary ownership to an upstream employee. For example, resource relationship resolver 110 determines temporary resource ownership and, using resource access manager 114, assigns temporary ownership of the resource to the manager of the user. In another example, if the manager of the user also changed job roles, then resource relationship resolver 110 determines temporary resource ownership and, using resource access manager 114, assigns temporary ownership to the nearest upstream employee. In an embodiment, resource relationship resolver 110 records the temporary ownership and, using resource access manager 114, periodically notifies the temporary owner until the temporary owner assigns a new owner.

Enterprise resource access transfer manager 106 determines whether the user is the only owner of the resource (decision block 220). In an embodiment, based on the access and privileges for the user fetched by one or more of resource management adapter(s) 116, enterprise resource access transfer manager 106 determines whether the user is the only designated owner of a resource. If the user is the only owner of the resource, then, depending on the user status change, the resource may become orphaned.

If enterprise resource access transfer manager 106 determines the user is the only owner of the resource (“yes” branch, decision block 220), then enterprise resource access transfer manager 106 determines ownership candidates (step 222). In an embodiment, enterprise resource access transfer manager 106 instructs resource relationship resolver 110 to use a scoring mechanism to determine candidates for new ownership of the resource by defining how likely someone is to get access to the resource. In an embodiment, resource relationship resolver 110 uses ML model 112 to establish a pattern of access control changes based on clusters of resource types and user characteristics to predict new access control privileges. For example, if a resource contains sensitive or confidential data (which may be identified using a natural language processing (NLP) technique that is trained to detect personal information and/or sensitive data), then resource relationship resolver 110 can assign a score of −10, where the range is 0 to −10, and −10 indicates the data is highly confidential. In another example, if the potential candidate has a history of handling confidential information of the type included in the resource, then resource relationship resolver 110 can assign a score of 10, where the range is 1 to 10, and 10 indicates a candidate having the most history of handling confidential data. In yet another example, if resource relationship resolver 110 determines that if the candidate does not have access to the resource, then the department operations will be impacted, then resource relationship resolver 110 assigns a score of 5, where the range is 1 to 10, and 10 indicates significant impact to the department. In an embodiment, resource relationship resolver 110 can use individual score types to determine a candidate. In another embodiment, resource relationship resolver 110 can add up scores of multiple types to determine a candidate. For example, resource relationship resolver 110 can add up the scores of the three types of scores discussed above and compare the total to a pre-defined threshold, and resource relationship resolver 110 considers a candidate with a score higher than the threshold to be a trusted potential owner of the resource. In another example, resource relationship resolver 110 may have a requirement for a minimum score for each type of score.

Enterprise resource access transfer manager 106 assigns a new owner (step 224). In an embodiment, enterprise resource access transfer manager 106 chooses a candidate from the employees that have access to the resource to be the new owner. In an embodiment, if there are multiple candidates that qualify, based on the scores of each candidate, enterprise resource access transfer manager 106, using the ownership determined by resource relationship resolver 110, grants ownership access to the candidate with the highest score, using resource access manager 114. In an embodiment, the new owner can delegate access to the resource to others, as needed, since enterprise resource access transfer manager 106 knows that the new owner has the best knowledge of the ramifications of providing access. In an embodiment where two or more candidates have the same score, resource relationship resolver 110 can employ a tiebreaker. For example, resource relationship resolver 110 may choose the candidate that had the most frequent access to the resource. In another example, resource relationship resolver 110 may choose the candidate with the longest time employed by the enterprise.

Responsive to assigning a new owner, or if enterprise resource access transfer manager 106 determines the user is not the only owner of the resource (“no” branch, decision block 220), then enterprise resource access transfer manager 106 revokes the owner access privilege of the user (step 226). In an embodiment, if the user has access to a resource but is no longer the owner, administrator, or super user of the resource, then enterprise resource access transfer manager 106 instructs resource access manager 114 to invoke the resource adapter of resource management adapter(s) 116 that corresponds to the resource to revoke the user's access to the resource.

Enterprise resource access transfer manager 106 transmits a notification of ownership and access changes (step 228). In an embodiment, in response to changing resource ownership and/or access level, enterprise resource access transfer manager 106 instructs resource access manager 114 to transmit a notification of the ownership and/or access changes, via user interface 126. For example, if the user is still employed by the enterprise, resource access manager 114 transmits a notification to the user that access to one or more resources has been changed or revoked. In another example, resource access manager 114 transmits a notification to the newly assigned owner of the resource that indicates a change in access and/or privileges. In yet another example, resource access manager 114 transmits a notification to the manager of the user that experienced the role change to inform the manager that the change in access level and/or ownership is complete.

Responsive to transmitting the notification, or if enterprise resource access transfer manager 106 determines a resource access privilege change is not needed (“no” branch, decision block 206), or if enterprise resource access transfer manager 106 determines the confidence in the determination does not exceed a threshold (“no” branch, decision block 208), then enterprise resource access transfer manager 106 ends execution. In an embodiment where enterprise resource access transfer manager 106 determines the confidence in the determination does not exceed a threshold, enterprise resource access transfer manager 106 instructs resource access manager 114 to initiate a continued business need (CBN) request for access to the resource for approval by the user if the user is still employed by the enterprise.

In an example scenario of a use case of enterprise resource access transfer manager 106, employee X sets up a shared workspace for the local team to use. Employee X has the role of administrator of the shared workspace. At some point, the location at which employee X works moves to a different location, and employee X joins a different team. The remaining team members that share the workspace want to rename the workspace to match the new location, however since none of them have administrator permission, the team members cannot change the workspace name. In an embodiment, enterprise resource access transfer manager 106 assigns ownership, i.e., administrator permission, to the member of the team that has the largest contribution to the workspace.

In another example scenario of a use case of enterprise resource access transfer manager 106, employee Y is a chief architect and created multiple architectural documents and design documents in a document management system such that the documents are shared across the organization. When employee Y leaves the organization, access to the documents that employee Y created is lost. In an embodiment, enterprise resource access transfer manager 106 detects the departure of employee Y from the change in the enterprise directory. Enterprise resource access transfer manager 106 then finds the documents shared by employee Y in the document management system. Enterprise resource access transfer manager 106 analyzes the level of access the employees of the enterprise have had and continues to grant the same level of access to active employees. For example, if an employee had editor access, then enterprise resource access transfer manager 106 continues to grant editor access. In addition, enterprise resource access transfer manager 106 determines which employees have made significant contributions to the documents and automatically assigns ownership access to those employees. Further, enterprise resource access transfer manager 106 does not grant access to documents that were not shared by employee Y.

In yet another example scenario of a use case of enterprise resource access transfer manager 106, employee Z is a cloud administrator that provisioned multiple cloud services. When employee Z then leaves the enterprise, users of the cloud services may lose access, and/or some parts of the services may not function properly. In an embodiment, enterprise resource access transfer manager 106 identifies collaborators that employee Z had added to the account associated with employee Z. Based on the access provided to the collaborators and the contributions made by the collaborators, enterprise resource access transfer manager 106 identifies and grants administrator access to those collaborators that meet a pre-defined criteria.

FIG. 3 is an example diagram of a distributed data processing environment in which aspects of one or more of the illustrative embodiments may be implemented, and at least some of the computer code involved in performing the inventive methods may be executed, in accordance with an embodiment of the present invention, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as enterprise resource access transfer manager 106 for managing access changes to enterprise resources. In addition to enterprise resource access transfer manager 106, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and enterprise resource access transfer manager 106, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in enterprise resource access transfer manager 106 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in enterprise resource access transfer manager 106 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
detecting, by one or more computer processors, a status change of an employment of a user in an enterprise;
retrieving, by one or more computer processors, an access level of the user associated with one or more enterprise resources;
based on the status change, determining, by one or more computer processors, the access level of the user associated with at least resource one of the one or more enterprise resources needs to change;
determining, by one or more computer processors, whether the user is an owner of the at least one resource;
responsive to determining the user is the owner of the at least one resource, retrieving, by one or more computer processors, an employee hierarchy; and
based on the employee hierarchy, assigning, by one or more computer processors, temporary ownership of the at least one resource to a first employee of the enterprise.

2. The computer-implemented method of claim 1, further comprising:
determining, by one or more computer processors, whether the user is an only owner of the at least one resource;
responsive to determining the user is the only owner of the at least one resource, determining, by one or more computer processors, one or more ownership candidates;
based on the determined one or more ownership candidates, assigning, by one or more computer processors, a new owner to the at least one resource;
revoking, by one or more computer processors, ownership access of the user to the at least one resource; and
transmitting, by one or more computer processors, a notification of a change of ownership of the at least one resource.

3. The computer-implemented method of claim 2, wherein determining the one or more ownership candidates further comprises:
determining, by one or more computer processors, a semantic equivalence between attributes of one or more potential owners and one or more properties of the at least one resource.

4. The computer-implemented method of claim 2, wherein the notification of a change of ownership of the at least one resource includes at least one of a notification to the user, a notification to the new owner, and a notification to a manager of the user.

5. The computer-implemented method of claim 1, further comprising:
responsive to determining the user is not the owner of the at least one resource, determining, by one or more computer processors, changes to the access level of the user to the at least one resource; and
modifying, by one or more computer processors, the access level of the user to the at least one resource.

6. The computer-implemented method of claim 1, wherein the status change of the employment of the user in the enterprise is selected from the group consisting of: a role change, a job change, a department change, a team change, a title change, a level change, a name change, and leaving the enterprise.

7. The computer-implemented method of claim 1, further comprising:
responsive to determining the access level of the user associated with at least one of the one or more enterprise resources needs to change, determining, by one or more computer processors, a confidence in the determination of the needed access level change exceeds a pre-defined threshold.

8. A computer program product comprising:
one or more computer readable storage media;
program instructions, stored on at least one of the one or more computer readable storage media, to detect a status change of an employment of a user in an enterprise;
program instructions, stored on at least one of the one or more computer readable storage media, to retrieve an access level of the user associated with one or more enterprise resources;
based on the status change, program instructions, stored on at least one of the one or more computer readable storage media, to determine the access level of the user associated with at least one resource of the one or more enterprise resources needs to change;
program instructions, stored on at least one of the one or more computer readable storage media, to determine whether the user is an owner of the at least one resource;
responsive to determining the user is the owner of the at least one resource, program instructions, stored on at least one of the one or more computer readable storage media, to retrieve an employee hierarchy; and
based on the employee hierarchy, program instructions, stored on at least one of the one or more computer readable storage media, to assign temporary ownership of the at least one resource to a first employee of the enterprise.

9. The computer program product of claim 8, further comprising:
program instructions, stored on at least one of the one or more computer readable storage media, to determine whether the user is an only owner of the at least one resource;
responsive to determining the user is the only owner of the at least one resource, program instructions, stored on at least one of the one or more computer readable storage media, to determine one or more ownership candidates;
based on the determined one or more ownership candidates, program instructions, stored on at least one of the one or more computer readable storage media, to assign a new owner to the at least one resource;
program instructions, stored on at least one of the one or more computer readable storage media, to revoke ownership access of the user to the at least one resource; and
program instructions, stored on at least one of the one or more computer readable storage media, to transmit a notification of a change of ownership of the at least one resource.

10. The computer program product of claim 9, wherein the program instructions to determine the one or more ownership candidates further comprise:
program instructions, stored on at least one of the one or more computer readable storage media, to determine a semantic equivalence between attributes of one or more potential owners and one or more properties of the at least one resource.

11. The computer program product of claim 9, wherein the notification of a change of ownership of the at least one resource includes at least one of a notification to the user, a notification to the new owner, and a notification to a manager of the user.

12. The computer program product of claim 8, further comprising:
responsive to determining the user is not the owner of the at least one resource, program instructions, stored on at least one of the one or more computer readable storage media, to determine changes to the access level of the user to the at least one resource; and
program instructions, stored on at least one of the one or more computer readable storage media, to modify the access level of the user to the at least one resource.

13. The computer program product of claim 8, wherein the status change of the employment of the user in the enterprise is selected from the group consisting of: a role change, a job change, a department change, a team change, a title change, a level change, a name change, and leaving the enterprise.

14. The computer program product of claim 8, further comprising:
responsive to determining the access level of the user associated with at least one of the one or more enterprise resources needs to change, program instructions, stored on at least one of the one or more computer readable storage media, to determine a confidence in the determination of the needed access level change exceeds a pre-defined threshold.

15. A computer system comprising:
one or more computer processors;
one or more computer readable memories; and
one or more computer readable storage media;
program instructions, stored on at least one of the one or more computer readable storage media for execution by at least one of the one or more computer processors via at least one of the one or more memories, to detect a status change of an employment of a user in an enterprise;
program instructions, stored on at least one of the one or more computer readable storage media for execution by at least one of the one or more computer processors via at least one of the one or more memories, to retrieve an access level of the user associated with one or more enterprise resources;
based on the status change, program instructions, stored on at least one of the one or more computer readable storage media for execution by at least one of the one or more computer processors via at least one of the one or more memories, to determine the access level of the user associated with at least one resource of the one or more enterprise resources needs to change;
program instructions, stored on at least one of the one or more computer readable storage media for execution by at least one of the one or more computer processors via at least one of the one or more memories, to determine whether the user is an owner of the at least one resource;
responsive to determining the user is the owner of the at least one resource, program instructions, stored on at least one of the one or more computer readable storage media for execution by at least one of the one or more computer processors via at least one of the one or more memories, to retrieve an employee hierarchy; and
based on the employee hierarchy, program instructions, stored on at least one of the one or more computer readable storage media for execution by at least one of the one or more computer processors via at least one of the one or more memories, to assign temporary ownership of the at least one resource to a first employee of the enterprise.

16. The computer system of claim 15, further comprising:
program instructions, stored on at least one of the one or more computer readable storage media for execution by at least one of the one or more computer processors via at least one of the one or more memories, to determine whether the user is an only owner of the at least one resource;
responsive to determining the user is the only owner of the at least one resource, program instructions, stored on at least one of the one or more computer readable storage media for execution by at least one of the one or more computer processors via at least one of the one or more memories, to determine one or more ownership candidates;
based on the determined one or more ownership candidates, program instructions, stored on at least one of the one or more computer readable storage media for execution by at least one of the one or more computer processors via at least one of the one or more memories, to assign a new owner to the at least one resource;
program instructions, stored on at least one of the one or more computer readable storage media for execution by at least one of the one or more computer processors via at least one of the one or more memories, to revoke ownership access of the user to the at least one resource; and
program instructions, stored on at least one of the one or more computer readable storage media for execution by at least one of the one or more computer processors via at least one of the one or more memories, to transmit a notification of a change of ownership of the at least one resource.

17. The computer system of claim 16, wherein the program instructions to determine the one or more ownership candidates further comprise:
program instructions, stored on at least one of the one or more computer readable storage media for execution by at least one of the one or more computer processors via at least one of the one or more memories, to determine a semantic equivalence between attributes of one or more potential owners and one or more properties of the at least one resource.

18. The computer system of claim 16, wherein the notification of a change of ownership of the at least one resource includes at least one of a notification to the user, a notification to the new owner, and a notification to a manager of the user.

19. The computer system of claim 15, further comprising:
responsive to determining the user is not the owner of the at least one resource, program instructions, stored on at least one of the one or more computer readable storage media for execution by at least one of the one or more computer processors via at least one of the one or more memories, to determine changes to the access level of the user to the at least one resource; and
program instructions, stored on at least one of the one or more computer readable storage media for execution by at least one of the one or more computer processors via at least one of the one or more memories, to modify the access level of the user to the at least one resource.

20. The computer system of claim 15, further comprising:
responsive to determining the access level of the user associated with at least one of the one or more enterprise resources needs to change, program instructions, stored on at least one of the one or more computer readable storage media for execution by at least one of the one or more computer processors via at least one of the one or more memories, to determine a confidence in the determination of the needed access level change exceeds a pre-defined threshold.
